(19) United States
(12) Patent Application Publication
(10) Pub. No.: US 2014/0324520 A1
(43) Pub. Date: Oct. 30, 2014

(54) METHOD FOR DETERMINISTIC SAFETY ANALYSIS IN NON-STATIONARY HIGH RISK SYSTEM, CONTROL METHOD AND CONTROL SYSTEM USING THEREOF

(71) Applicant: Diakont Advanced Technologies, Inc., San Diego, CA (US)

(72) Inventors: Mikhail Evgenievich FEDOSOVSKIY, Saint Petersburg (RU); Alexander Evgenievich SHERSTOBITOV, Saint Petersburg (RU); Vadim Igorevich DUNAEV, Saint Petersburg (RU); Yurii Vladimirovich KOPIEV, Moscow (RU)

(73) Assignee: Diakont Advanced Technologies, Inc., San Diego, CA (US)

(21) Appl. No.: 14/058,612

(22) Filed: Oct. 21, 2013

Related U.S. Application Data
(63) Continuation-in-part of application No. 11/943,531, filed on Nov. 20, 2007, now Pat. No. 8,566,139.
Application No. 11/943,531 is a continuation of application No. PCT/RU2006/000268, filed on May 22, 2006.

(30) Foreign Application Priority Data
May 20, 2005 (RU) 2005116169

(51) Int. Cl. G06Q 10/06

(52) U.S. Cl. CPC G06Q 10/0635
USPC 705/7.28

(57) ABSTRACT

This invention relates to a method and systems of safety analysis of engineering processes and may be used for safety analysis of nuclear power stations.

According to the invention, distribution of risk factors is analysed on different stages of the engineering process, and safety intervals are determined where safety conditions remain invariable. The method further includes analysis of failures transitions from one safety interval into another by means of cause-effect analysis. Based on the results of this analysis, deterministic safety models are created for possible scenarios of transition of failures from one safety interval into another.

A method and system according to the invention provide quantitative safety analysis and evaluation for engineering processes in variable safety conditions and enable creating valid safety requirements to perform optimisation of an engineering processes control system.

The present invention relates to quantitative safety analysis, in particular, to a method of determining safety factors in high risk non-stationary engineering systems and processes, such as a process of reloading nuclear fuel in a nuclear power plant (APP) and a control system and control method using thereof.

Many current modelling systems are designed for performing probabilistic safety analysis solely and provide for the qualitative evaluation of failure probability of the engineering process. According to this approach, safety analysis was usually restricted to the brief characterisation of operating elements called “objects” and possible failures called “initial events”, and subsequent functional analysis of probability of one or the other process discontinuity or object damage for a small number of initiating events causing such discontinuity or damage.

Other methods use a deterministic approach which reviews the physical characteristics of a system, for example, temperature, pressure, etc., and evaluates the system solely on the basis of this quantitative information.

Some modelling systems combine a statistical and probabilistic approach to compare the present state of a component with its past history and to determine what could happen next. The current modelling methods do not emphasize an heuristic approach to consider the dynamic interaction between the components of a system or between the systems themselves when determining the present and future performance of a plant.

However, the growing complexity of engineering processes, in particular those connected with exploitation of thermoelectric power stations (TPS) and especially APP, due to a large number of logical and functional relations and time-dependence of safety parameters requires the development of new approaches to safety evaluation.

For example, U.S. patent application 20040086071 discloses an optimum evaluation system for safety analysis of a nuclear power plant, wherein data derived from results of a various kinds of experiments are used to improve codes so that the calculated results do not exceeds the experimental results at any condition, so that a sufficient safety margin is maintained at any condition. The system provides for quantification and standardization of the analysis method to three procedures. A first procedure relates to applying conditions and codes consists of a step for describing an accidental scenario, a step for selecting a subject power plant, a step for confirming main conditions and deciding the raking, a step for selecting an optimum code, a step for arranging documents related with the codes, and a step for deciding applicability of the codes. A second procedure evaluates the codes and deciding displacement of variables consists of: a step for evaluating codes and deciding evaluation matrix related to the displacement decision for the variables, a step for deciding nodding of a power plant, a step for deciding accuracy of the codes and the experiments, a step for analyzing and evaluating a scale effect decision, a step for deciding input variables of a nuclear reactor and their states related with the factors obtained by analyzing uncertainty and sensitivity, a calculating step of sensitivity of a power plant, a step for statistically evaluating uncertainty and a step for deciding a total uncertainty. A third procedure relates to analyzing sensitivity and evaluating uncertainty conducted by a step for evaluating bias which have not been considered in the first and the second procedures to decide a temperature of a final coating material.

This system allows estimating the safety of the existing objects only and cannot provide developing technical specification for the safety measures at the modernization and at the development of the new equipment for APP.

Attempts were made to reduce the problem of safety evaluation to selection of one possible decision of a plurality of decisions stored in a data base, which would be the most appropriate for the case. Thus, according to a method of a computer-aided safety analysis of a nuclear reactor (WO03/005376), functioning of APP is limited within the range of its safe exploitation, which is defined by the following steps:
a) providing the results of previously implemented safety analysis;
b) check up if the range of the safe exploitation of the APP defined earlier is applicable in the new operating conditions of the APP

However, this method is applicable to safety analysis of only those APP's, which are already in operation and not to newly constructed or modified APP's.

U.S. Pat. No. 4,632,802 discloses a system for safety evaluation of APP, which provides continuous operation of APP in case of failure or unavailability of one or several APP elements. According to U.S. Pat. No. 4,632,802, the system provides for monitoring and evaluating the degree of risk associated with continued operation of a nuclear power plant while one or more plant components has failed or is otherwise unavailable. The apparatus has several functional sections, including means for storing a plant-specific data base of component-level core damage logic paths and component level failure probabilities, means for selecting plant condition scenarios by modifying the component failure probabilities to represent plant components actually or potentially unavailable, means for associating a figure of merit with the change in risk of core damage resulting from the unavailable components, and means for displaying the figure of merit relative to a base or reference value. As an interactive tool in the plant, the apparatus PSES displays the probability or risk of core damage almost instantly for any given state of plant readiness.

Similarly, the known system can be used for safety evaluation of existing APP and not for the newly developed or modified plants to optimize the APP equipment parameters, like a control system, to choose necessary and sufficient number of protection layers and of locks providing the object safety.

Another method for deterministic safety analysis based on the risk conception (EP1378916) includes ranking of initiating events depending on frequency of their occurrence, the threshold level of frequency of initiating events, acceptance criteria with adjustable level of conservatism, conservatism value using the methodology of the safety analysis, wherein the analysis of the events is performed using deterministic analysis in case the frequency of the event initiation exceeds the threshold level, or probabilistic analysis in case the frequency of the event initiation is below the threshold level.

The known method includes also the identification of the additional system of failures, which are not in a direct relation with initiating events, and definition of the common threshold frequency value for the combination of the initiating events frequency and additional failures frequency. Later the additional system of failures is appended to the safety analysis until the total frequency of event and additional failures does not exceed the threshold frequency level.

While the known method provides determining conditions when either deterministic or probabilistic method would be preferable, it does not provide for the use of both methods when needed.

Further, EP 0411873 discloses a control system for a plant using a modelling system employing expert, deterministic and probabilistic modelling methods. This modelling system is implemented as a hierarchical structure of independent objects interacting with each other. Each object represents an element or a system. Objects are connected to each other through a data base available for all objects. The structure of the object module and the hierarchical structure are standardized and provide introducing new elements or systems by introduction of standard object modules including specific object model. The object model contains a deterministic model of the element degradation, probabilistic model of the element degradation and expert rules combining deterministic and probabilistic models with experts' knowledge aiming to determine the current state of the object and produce recommendations concerning future actions with respect to the object.

Further, according to international standards, a procedure for probabilistic safety analysis of APP in defined in Procedures for conducting probabilistic safety assessment of nuclear power plants (level 1), International Atomic Energy Agency, Vienna, 1992, STI/PUB/888. According to this standardised procedure, a probabilistic safety analysis of APP includes the following steps: input data acquisition and analysis, selection of input events, determining safety functions, determining functional system interconnection, determining successful functioning criteria, grouping input events, modelling a sequence of events and systems, and performing quantitative and qualitative safety analysis.

The above discussed approaches proved their effectiveness when applicable to stationary, in the context of safety conditions, systems only, wherein safety conditions either invariable or change relatively slowly, for example, as a result of ageing of system elements.

However, many complex engineering systems operate in safety conditions, which are both time and location-dependent and could vary within a single technological operation, as well as in course of a technological cycle, that makes the above discussed safety analysis approaches inapplicable.

The above said relates for example, to technological processes of transportation, which are typically characterized by significant changes in safety conditions both from one technological operation to the other, and within a single technological operation. There is a multitude of logical and functional inter-relations between operations that affect the overall safety of the engineering process.

As a result, known methods and systems become unreliable in case of safety analysis of complex engineering processes such as a process of reloading a nuclear fuel. The non-stationary character of such engineering processes makes impossible a reliable evaluation of safety conditions using the known methods and approaches.

The object of the present invention is creating a method and a system of safety analysis and evaluation of engineering processes by means of computer-aided probabilistic safety analysis that would provide a quantitative safety evaluation of engineering processes whose safety conditions are time and location dependent and vary constantly, either within a single technological operation or in the course of a technological cycle, or both.

Another object is to provide a method of safety analysis, allowing to define valid safety requirements for the structural optimization of an engineering process control system, including determining necessary and sufficient number of protectors and locks, in particular with respect to processes of nuclear fuel reloading.

Further, a method and system according to the invention provide for reliable safety evaluation, which is often one of the major factors considered when developing a new engineering process and/or modifying existing plants.

A method and system according to the invention further provide for quantitative safety analysis of the engineering process.

Moreover, the method and system may be used in safety analysis of nuclear fuel reloading and other engineering processes with high level of risk.

### DEFINITIONS

The following definitions will be used throughout the detailed description of the invention and claims:
a process parameter Pᵢ (1<i<n) is defined as any measurable physical parameter related to or acting upon an object involved in an engineering process, such as a load, impact, force, such as torque force, or a condition such as temperature, pressure, etc;
maximum safe operation parameter (MSP), Pᵢₛₘₐₓ defined as maximum with is permissible value of the said parameter in accordance with safety requirements for the engineering process under analysis, further, safety criterion;
overrun of Maximum Safety Parameter (OMSP) is excess of the normal value or abnormal behaviour, such as downfall or break out of an object involved in a process or operation;
failure Fᵢ=f(Pᵢ) of an engineering process is a process malfunction or deviation of process parameter Pi from a normal value;
a risk factor (a source of danger) is defined as such failure Fᵢ=f(Pᵢ) of a high risk technological process, which result in overrun of at least one process parameter Pᵢ> [symbol] ;
risk factor zone of action Zi (Fᵢ=f(Pᵢ> [symbol] )) is defined as a plurality of parts of engineering process, affected by the said risk factor, including those parts where this particular risk factor arises and causes overrun of the said at least one process parameter as well as a number of down flow parts where consequences of the said risk factor can cause overrun of other process parameters;
safety interval Ri is defined as a sub-plurality of parts of engineering process Rⱼ={F₁, F₂, . . . Fᵢ, . . . Fₙ} (1<j<m), wherein a combination of said risk factors

$${\sum }_{i = 1}^{n} {F}_{i}$$

remains invariable (constant). According to the invention, a method of computer-implemented safety analysis of a high risk engineering process with non-stationary objects characterized by variable risk factors is provided, which comprises the following steps:
a. dividing, via a computer, the said high risk engineering process into safety intervals Rj={F1, F2, F3 . . . Fn} (1<n<m), wherein the safety interval is a series of at least one process stage where a combination

$${\sum }_{i = 1}^{n} {F}_{i}$$

of risk factors remains invariable for all stages of the said series; and
b. for each safety interval, creating, via the computer, a safety model and performing, via the computer, qualitative and quantitative safety analysis.
c. correspondingly modifying the engineering process to reach the required safety parameters.

Prior to these steps, the method possibly includes a step of collecting process-specific data.

Also, preferably, the method comprises creating a computer readable representation of a high risk engineering process based on the collected or available data, which could be in the form of tables, charts, and any other form of computer readable data.

Further, the method preferably comprises analysis of the obtained process-specific data, preferably using the computer readable representation, with respect to safety regulations to determine safety criteria.

Further, preferably, the step of modelling comprises creating a deterministic safety model, while the qualitative and quantitative safety analysis comprises at least a step of calculating risk factors probabilities.

Further, it is appreciated that safety criteria are defined in terms of maximum safe operation parameters including process parameters and/or forces acting upon objects Bi involved in the said process. The maximum safe operation parameter P_{isafe} is defined as maximum permissible value of the said parameter in accordance with safety regulations for the given engineering process.

Further, prior to analysis, potential risk factors can be determined based upon analysis of engineering process, wherein the risk factors are defined above as such engineering process and operation parameters failures, which may result in at least one overrun of the said maximum safe operation parameters;

Further, to define safety intervals of the engineering process as intervals wherein safety conditions remain invariable, prior to safety analysis, a distribution analysis of the above defined risk factors throughout different stages of the said engineering process can be performed, e.g. using a process representation in computer readable form;

Further, upon distribution analysis, sequential transition of failures of the said engineering process and operation parameters from one to another safety interval are analysed using cause-effect analysis; and, finally,

at least one deterministic safety model is developed based on analysis of possible scenarios of sequential transitions of engineering process failures from one to another safety interval.

Further analysis and safety evaluation can be implemented using at least one operation of the following sequence of operations:
creating at least one of logical and logical-probabilistic model for each process failure, which results in overrun of at least one process parameter, wherein the said model is created based on the analysis of possible events resulting in respective failures of the engineering process;
based on analysis of non-stationary safety conditions and propagation of risk factors in each stage/part of an engineering process, in particular by creating a diagram process partitioned into safety intervals, switching to analysis of stationary safety analysis;
creating a deterministic model of safety intervals, taking into consideration possible scenarios of transition of failures from one to another safety interval.

Based on the obtained deterministic models of safety intervals as described above and taking into consideration possible scenarios and logical-probabilistic models of occurrence of failures in the engineering process, deterministic-probabilistic safety models are further created for the whole engineering process.

One of the specific features of the claimed method is the analysis of cause-effect relations between risk factors, possible failures in the engineering process and the function of protections and locks at each stage of the engineering process.

As risk factors, one should consider failures in the engineering process, which may result in overruns of normative impact on the units, components of units (devices), and other objects, when these input actions are subject to safety regulations established for the given engineering process.

Another feature of the method is that the analysis of propagation of areas of influence of risk factors is performed by analysing each separate stage/part of a technological operation, and defining those risk factors that result in at least one overrun of the input action.

Another feature of the method is creating logical-probabilistic models of possible failures in the engineering process, where each initial event is considered with the probability of its occurrence obtained based on the analysis of statistical data for the given engineering process.

It shall be appreciated that, when performing safety analysis and evaluation of an engineering process, objects subject to safety evaluation includes non-stationary objects, such as the engineering process as a whole, stages of engineering process, products, devices, units of devices, which are characterised by safety conditions varying in time and allocation of the given product, unit or device, in particular, depending on which stage of the engineering process a given product, unit or device is allocated.

One more feature of the claimed method is that, based on the analysis of sequential propagation of risk factors throughout the engineering process, it is possible to switch from consideration of an engineering process as a non-stationary object to the consideration of stationary parts of the engineering process, that simplifies greatly and contributes to the reliability of the method of safety analysis.

Another feature of the invention is that, by performing quantitative safety analysis of the engineering process it is possible to determine the necessary and sufficient quantity of protectors and locks.

Additionally, based on the results of safety analysis and evaluation according to the invention, a control system can be further optimized, so that valid reliability parameters of equipment could be determined.

The invention can be further implemented in a system for safety analysis and evaluation of an engineering process, the system comprising:
a central processor for performing the safety analysis and evaluation of engineering process;
a storage means for storing engineering process-specific data;
a modelling means for modelling of engineering process; and
a computation means for calculation of probabilistic safety parameter, wherein
the storage means stores process-specific data for further analysis of safety regulations based on which data a list of safety criteria and a list of risk factors defined in terms of overruns of maximum safe operation parameters are created; and possibly, other data used as a basis for analysis of failures in engineering process, and for development of a list of failures in engineering process that result in maximum safe operation parameters overruns;
wherein the system further comprises:
a means for analysis of risk factors distribution areas and partitioning of engineering process into safety intervals, for which safety conditions remain invariable; and
a means for analysing transitions of engineering process failures from one safety interval to another by means of cause-effect analysis;
wherein the modelling means comprises means for creating deterministic safety models taking into consideration possible scenarios of transitions of engineering process failures from one to another safety interval; and
the computation means are implemented so as to enable calculation of indices for at least individual types of events.

According to the invention, a system further comprises a means for creating a verbal model of an engineering process, the verbal model comprising the description of operating conditions and safety parameters.

Further, the system preferably comprises a means for creating a deterministic-probabilistic model.

Further, a system preferably comprises means for calculating probabilistic safety indices.

Further, a system preferably comprises means for analysis of safety indices characterizing the contribution of separate technological operations, protectors and locks into a composite safety index of the engineering process of nuclear fuel reloading.

Further, the system preferably contains means for creating and selecting scenarios of development of failures within the engineering process using statistic data on the probabilities of occurrence of different events for the given engineering process, stored in a database.

Further, the system preferably contains means for creating a diagram of an engineering process, means for compiling a list of failures in an engineering process, a list of initial failures and a list of protectors and locks.

Other features and characteristics of the claimed method and system for safety evaluation are described in more details below by the example of a method and system for safety evaluation of the process of the nuclear fuel reloading with references to the figures attached.

It shall be also appreciated that the below example of implementation should not be treated as limiting the invention, while the method and system as claimed in the appended claims may be used for safety analysis and evaluation of any engineering process where it may be required.

### BRIEF DESCRIPTION OF THE DRAWINGS

FIG. 1—a schematic diagram illustrating different stages of a technological operation “an installation of a fuel assembly into a reactor”;

FIG. 2—a verbal model for a safety analysis of an engineering process;

FIG. 3A—one part of a deterministic model of a transporting-technological operation “the installation of a fuel assembly into a reactor”;

FIG. 3B—the other part of the deterministic model of a transporting-technological operation “the installation of a fuel assembly into a reactor”;

FIG. 4—a typical logical-probabilistic model of occurrence of an overrun of a maximum safety parameter (OMSP, Overrun of Maximum Safety Parameter), such as an acceptable safety impact; FIG. 5—a deterministic-probabilistic model of a process of nuclear fuel reloading;

FIG. 6. —enlarged block scheme of a control system for controlling a re-loading machine;

FIG. 7—diagram showing how the operation of “re-loading of fuel cell into a nuclear reactor” is splitted into safety intervals;

FIG. 8—a deterministic model of an operation of “re-loading of fuel cell into a nuclear reactor”;

FIG. 9—logical-probablistic model of the initiating event “Fall down of Fuel cell”;

FIG. 10—a deterministic model of the process failure for safety interval R07;

FIG. 11—a deterministic model of the process failure for safety interval R19;

FIG. 12—a deterministic model of the process failure for safety interval R18;

FIG. 13—a deterministic model of the process failure for safety interval R17;

FIG. 14—a logical probabilistic model of the process failure F11 for safety interval R17;

FIG. 15—a sequence of models F123;

FIG. 16—a logical probabilistic model of the process failure F117 for safety interval R21+;

FIG. 17A—a first part of a flow chart of an algorithm of quantitative safety analysis according to the example implementation;

FIG. 17B—a second part of the flow chart of an algorithm of quantitative safety analysis according to the example implementation;

FIG. 17C—a third part of the flow chart of an algorithm of quantitative safety analysis according to the example implementation;

FIG. 18—a flow chart of an algorithm of graphic representation of a safety model.

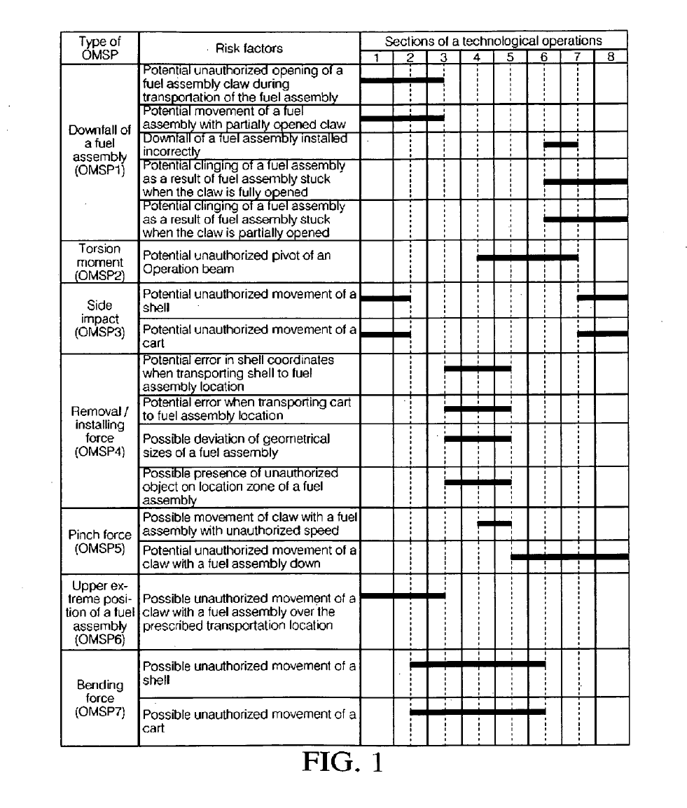

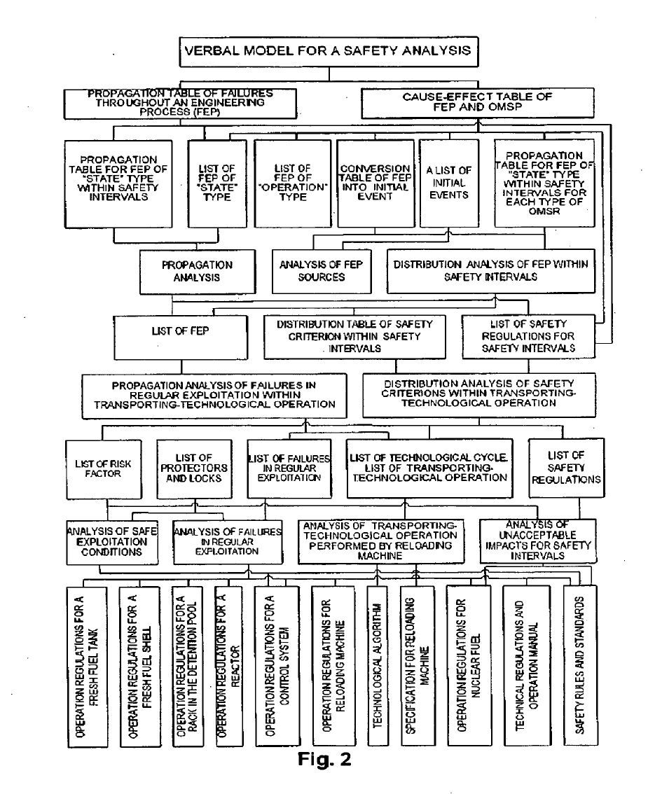

The invention will be further illustrated with reference to an example of a system for safety analysis and evaluation of an engineering process of reloading a core region of a nuclear reactor WWER(Water/Water-Energy Reactor)-1000, designed by the Russian Kurchatov Institute, Moscow.

The safety analysis of an engineering process for refuelling a core region is implemented using a system for deterministic safety analysis of an engineering process, wherein the system comprises a central processor for performing safety analysis of an engineering process, a means for storing engineering process data, and a means for computation of probabilistic safety factors (indices) for each type of event and a cumulative safety index for the overall process.

A data storage means comprises both (i) information relating to industry standards and normative technical documentation, such as process-specific safety regulations, which is used as initial data for creating a list of safety criteria, and (ii) a list of actual overruns of acceptable safety parameters for the current nuclear power plant, engineering process or technological operation, to use in analysis of possible failures of the engineering process and for compilation of a list of failures that result in possible occurrence of OMSP.

Further, optionally, a system contains a means for creating a verbal model of an engineering process, including description of operating conditions and limits, a means for creating a deterministic-probabilistic safety model, a means for calculation of probabilistic safety indices, a means for creating a logic-probabilistic model and other calculation means.

The safety analysis and evaluation procedure according to the invention comprises the following sequence of operations.

At the first stage, initial data is collected, including normative-technical and exploitation documentation for a reloading machine, a control system, a product to be reloaded, engineering algorithms, a service area diagram, transporting-technological operations diagram and other required documents.

At the second stage, the input information is analysed to generate the following interim documents, including but not limited to:
1. A Schematic Block Diagram of an Engineering Process

This diagram is typically represented as a multi-level structure illustrating a process of reloading a core region of a reactor, in combination with associated technological cycles and transporting-technological operations. The reloading process is represented as a sequence of technological cycles, wherein a list of cycles is defined on the basis of technical specification of a reloading machine, such as MPS-V-1000 U4.2 in the current example implementation.

According to the example, a process of reloading consists of 22 types of technological cycles with fuel assemblies, including the steps of: blowing up the assembly, inspection of installation level of the fuel assembly in the reactor, inspection of nests for installation of fuel assemblies in the reactor; 5 types of technological cycles involving elements affecting functionality (clusters), 4 types of technological cycles involving operations with plugs of a hermetical case.

Each technological cycle consists of a predetermined number of transporting-technological operations. For instance, according to the present example, the process includes 11 types of transporting-technological operations with fuel assemblies, 4 types of transporting-technological operations with clusters, and 2 types of transporting-technological operations with the plug of hermetical case.
2. A List of Safety Criteria

The safety criteria throughout the current specification are defined as Maximum Acceptable Safety Parameters of normative impacts on a reloaded product (also, Maximum Safe Operation Parameter Pᵢₘₐₓ, see Definitions).

An overrun of the acceptable parameter is the failure consisting in that normative impact as defined by the safety regulations is exceeded. For different kinds of impacts to the reloaded product, different safety parameters could apply. Therefore, the safety criterion would be non-deviation from normative impacts to a given object, such as a reloaded product.

The safety criteria are determined upon analysis of Standard Norms and Rules, and exploitation documents of the nuclear fuel.

The approximate list of safety criteria at the reloading of the core region of the reactor (handling fuel assemblies) is shown in the Table 1.

TABLE 1

| | Safety criteria, Maximum | |
|---|---|---|
| Type of | Safe Operation Parameter | |
| impact | (MS Pᵢₛₘₐₓ) | Safety Regulations |
| Downfall | Fuel assembly downfall is | Article 4.2.8 of the “Safety |
| of a fuel | not permitted | regulations for storage and |
| assembly | | transportation of a nuclear fuel |
| | | in a nuclear power engineering |
| | | apparatuses” PNAE G-14-029- |
| | | 91 |
| Torsion | Torsion torque is not | Article 8.2.7 of the operating |
| torque | permitted | manual “Complex of cassettes |
| | | WWER-1000” |
| | | 0401.22.00.000RE |
| Side | Hitting a beam of a | Article 6.5.11 of the “Safety |
| blow | reloading machine when | regulations for storage and |
| | transporting fuel | transportation of nuclear fuel in |
| | assemblies, by a | nuclear power engineering |
| | construction elements of a | apparatuses” PNAE G-14-029- |
| | reactor or a detention pool | 91 |
| | is not permitted | |
| Removal/ | Force of removal must not | Article 8.2.4 of the operating |
| Mounting | exceed 2205 N | manual “A complex of cassettes |
| Force | Mounting force must not | WWER-1000” |
| | exceed 735 N | 0401.22.00.000RE |
| Pinch | Pinch Force must not | Article 8.2.3 of the operating |
| force | exceed 9800 N | manual “A complex of cassettes |
| | | VVER-1000” |
| | | 0401.22.00.000RE |
| Upper | A used fuel assembly | Article 6.5.11 of “Safety |
| extreme | should not be elevated | rugulations for storage and |
| position | above a marker showing a | transportation of nuclear fuel in |
| of a fuel | water layer sufficient to | nuclear power engineering |
| assembly | provide safety of personnel | apparatuses” PNAE G-14-029- |
| | engaged in reloading of | 91 |
| | nuclear fuel | |
| Bending | Bending force is not | Article 6.5.11 of “Safety |
| force | permitted | regulations for storage and |
| | | transportation of nuclear fuel in |
| | | nuclear power engineering |
| | | apparatuses” PNAE G-14-029- |
| | | 91 |
| Tensile | Maximum acceptable | Article 8.2.5 of the operating |
| load | tensile load applicable for | manual “Complex of cassettes |
| | removal of a fuel | VVER-1000” |
| | assembly from a reactor | 0401.22.00.000RE |
| | must not exceed 39200 N | |
| | for initial 40 mm | |
| Fuel | Reloading of a fuel | Article 10.6 of the operating |
| assembly | assembly with mechanical | manual “Complex of cassettes |
| self- | defects (breakage of | VVER-1000” |
| destruction | details or parts of units) is | 0401.22.00.000RE |
| | not permitted | |
| Overheating | Reloading of a fuel | Article 4.2.11 of “Safety |
| of | assembly at the | regulations for storage and |
| a fuel | decreased water level in | transportation of nuclear fuel in |
| assembly | the detention pool is not | nuclear power engineering |
| | permitted | apparatuses” PNAE G-14-029- |
| | | 91 |

3. The next step is defining a list of failures in the engineering process and operation conditions that may result in OMSP (overrun of the maximum safety parameter), and hence, may constitute a Risk Factor, where risk factor is defined as such failure Fᵢ=f(Pᵢ) of a high risk technological process, which results in overrun of at least one process parameter Pᵢ> [symbol] .

Herein, failures in the engineering process in the step of core region reloading are defined as failures in regular exploitation, including, but not limited to the following:
Unapproved movement of machinery
Unapproved speed of movement of machinery
Unapproved direction of movement of machinery
Error in positioning of machinery to prescribed coordinates
Positioning of machinery to non-prescribed location
Positioning of a reloaded product to/on aprescribed location
Presence of unauthorized objects in a reloaded products area
Deviation in dimensions of reloaded products
Power supply loss
Seismic impact, etc.

In general, engineering process failures could be separated into two groups:
Operation failures; for instance, unapproved movement of a shell;
Status failures; for instance, the fuel assembly claw is positioned in the intermediate state.

The total number of failures of the engineering process that will be considered within the present process is 55, including 16 failures relating to status failures.
4. Partitioning diagram showing how transporting-technological operations could be partitioned into intervals with invariable safety conditions

The next stage is creating a diagram of partitioning of transporting-technological operations into intervals with invariable safety conditions.

Further, a process of partitioning transport-technological operations into intervals with invariable safety conditions will be discussed in more detail with reference to the operation “Installation of a fuel assembly into a nuclear reactor”.

The first step is compiling a table containing data relating to OMSP, respective risk factors, and areas of influence of risk factors. The area of influence is defined as a part of a technological operation where a particular risk factor may result in unacceptable impacts. An example table may be presented as shown below (for some safety criteria)

TABLE 2

| OMSP, | | |
|---|---|---|
| Overrun | | |
| of Max- | | |
| imum Safety | | |
| Parameter, | | |
| or Over- | | |
| run of | | |
| Safety | | |
| Criterion | Risk factor, Fᵢ = f(Pᵢ) | Area of influence of a risk factor Fᵢ |
| Fuel | Unauthorized fuel | Initial position corresponds to—the |
| assembly | assembly gripper | transporting position with a fuel |
| downfall | opening | assembly. End position is defined as |
| (OMSP1) | | a position when a shank of a fuel |
| | | assembly is located within 100 mm |
| | | from the installation position |
| Torque | Unauthorized pivot of | Initial position is defined as a position |
| (OMSP2) | a working beam | when the shank of a fuel assembly is |
| | | located at a head level of the |
| | | installed fuel assemblies. End |
| | | position corresponds to position |
| | | when the fuel assembly is installed |
| | | into a reactor slot |
| Pinch force | A claw with a fuel | Initial position corresponds to |
| (OMSP5) | assembly moves | position when a fuel assembly shank |
| | downward at the | is within 100 mm distance from the |
| | unapproved speed | target location in a slot of a reactor. |
| | | End position corresponds to position |
| | | when the fuel assembly is installed |
| | | into a slot of a reactor. |

Further, a procedure is described for compiling a diagram of distribution of areas of influence of risk factors.

First, an engineering process is presented on a diagram in the following system of coordinates:
on the horizontal axis, initial and endpoints of influence of risk factors are marked;
on the vertical axis, points corresponding to possible types of damage are marked.

Then, for each risk factor, an influence area is marked by a horizontal line. Further, initial and end points of obtained influence areas (they are shown by dotted lines) are connected by vertical lines to separate the whole technological operation into intervals, where the safety conditions remain invariable, for instance, the number and types of possible damages of fuel assemblies is constant.

The obtained safety intervals represent stationary, in the context of safety conditions, objects, where standard methods of calculation of probabilistic safety analysis are applicable.

In this way, the whole engineering process can be represented as a set of sequentially connected safety intervals. In this representation, safety intervals are connected to each other not only by a sequence of technological operations, but also by cause-and-effect relations of engineering process failures, which could happen within these intervals.
5. Table 3 “Propagation of Failures”

This table is compiled based on analysis of failure transitions from one safety interval to another.

A characteristic feature of multiple transporting-technological operations, in particular, nuclear fuel reloading operations, is that if a failure has occurred on some safety interval in the course of an engineering process, this may or may not result in the overrun of maximum safety impact on a reloaded product at this interval. For instance, if a failure has occurred on a safety interval when a fuel assembly was moved to a transit position, the result could be that a fuel assembly is not lifted to the required level, its lower part projecting outwards from the working beam. Within the given safety interval this failure may not result in a fuel assembly damage, however, later, when the fuel assembly will be moved through a transporting passage, it may be curved by collision with structures in the transporting passage.

To avoid the above described failures, propagation of failures shall be traced and analysed throughout the engineering process shall be made. To simplify analysis of failures transitions from one safety interval to another, according to the invention, the next step is compiling “A table of failures propagation throughout an engineering process” (further referenced as Failure Propagation Rules).

As a result of the analysis, a combined table of failures is compiled, where all possible failures in engineering process and all safety intervals for a given operation are listed. This table is compiled using Failure Propagation Rules developed earlier. An example table for the first three intervals of the operation “Installation of a fuel assembly” is presented below.

TABLE 3

| | | Safety | | | Safety | | | Safety | | | |
|---|---|---|---|---|---|---|---|---|---|---|---|
| | | Interval | | | Interval | | | Interval | | | |
| Failure | | R1.15 | | | R1.16 | | | R1.17 | | | |
| designation | Description of failure | In | | Out | In | | Out | In | | Out | . . . |
| Failure | The shell is out of | + | × | + | + | × | + | + | 2 | − | |
| 2.1.6.1 | required coordinates of | | | | | | | | | | |
| | installation/removal of | | | | | | | | | | |
| | a fuel assembly | | | | | | | | | | |
| Failure | The trolley is out of | + | × | + | + | × | + | + | 2 | − | |
| 2.2.6.1 | required coordinates of | | | | | | | | | | |
| | installation/removal of a | | | | | | | | | | |
| | fuel assembly | | | | | | | | | | |
| Failure | The trolley is out of | − | 4 | − | − | 4 | − | − | 4 | − | |
| 2.2.6.2 | required coordinates of | | | | | | | | | | |
| | the transporting passage | | | | | | | | | | |
| | entrance | | | | | | | | | | |
| Failure | The claw with the fuel | + | 1 | − | − | 1 | − | − | 1 | − | |
| 2.4.7.1 | assembly is above the | | | | | | | | | | |
| | transit position | | | | | | | | | | |
| Failure | The claw with the fuel | + | 1 | − | − | 1 | − | − | 1 | − | |
| 2.4.7.2 | assembly is below the | | | | | | | | | | |
| | transit position | | | | | | | | | | |
| Failure | The claw with a picked | − | 4 | − | − | 4 | − | − | 4 | − | |
| 2.4.7.3 | up fuel assembly is “in | | | | | | | | | | |
| | the transit position with | | | | | | | | | | |
| | the product” | | | | | | | | | | |
| Failure | The claw is not on the | − | 4 | − | − | 4 | − | − | − | − | |
| 2.4.7.4 | required coordinates of | | | | | | | | | | |
| | installation/removal of | | | | | | | | | | |
| | the fuel assembly (by | | | | | | | | | | |
| | the height) | | | | | | | | | | |
| Failure | Discrepancy between | − | 2 | − | − | 2 | − | − | 3 | − | |
| 2.5.7.1 | the actual and required | | | | | | | | | | |
| | position of the claw—it | | | | | | | | | | |
| | is open | | | | | | | | | | |
| Failure | Discrepancy between | − | 4 | − | − | 4 | − | − | 4 | − | |
| 2.5.7.2 | actual and required | | | | | | | | | | |
| | position of the claw—it | | | | | | | | | | |
| | is closed | | | | | | | | | | |
| Failure | The claw latch is in the | + | × | + | + | × | + | + | × | + | |
| 2.5.7.3 | intermediate position | | | | | | | | | | |
| Failure | The working beam is not | + | × | + | + | × | + | + | × | + | |
| 2.7.7.1 | at zero degrees position | | | | | | | | | | |
| | (required position) | | | | | | | | | | |
| Failure | The working beam is not | − | 4 | − | − | 4 | − | − | 4 | − | |
| 2.7.7.2 | at 45 degrees position | | | | | | | | | | |
| | (required position) | | | | | | | | | | |
| Failure10 | The fuel assembly is | − | 4 | − | − | 4 | − | − | − | − | |
| | installed out of the | | | | | | | | | | |
| | reactor slot | | | | | | | | | | |
| Etc. | | | | | | | | | | | |

In the above table, the symbols “+” and “−” denote, respectively, the presence and absence of potential failure at the beginning or at the end of a safety interval, while the numbers “1” . . . “6” correspond to the number of a failure propagation rule for a given engineering process. Example rules presented below.

Rule 1: The influence of a failure is terminated at the moment of a regular movement of machinery. For instance, the influence of the failure “Error of setting the shell to the required coordinates” is terminated as soon as the shell start moving regularly.

Rule 2: A potential failure in the engineering process is eliminated provided a safety interval is realized in accordance with the engineering process. For instance, installation of a fuel assembly into a reactor slot eliminates the influence of the following failures: “The working beam is not at 0 degrees position” and “The bridge or trolley are out of coordinates of installation/extraction of the reloaded product”, etc.

Rule 3: The influence of a failure in the engineering process is terminated upon unconditional conversion of failure into an overrun of a safety parameter. For instance, unapproved opening of a fuel assembly claw during transportation of a fuel assembly (this is a failure) unconditionally results in the fuel assembly drop (this is an overrun of a safety parameter).

Rule 4: A failure in the engineering process terminates its influence in a safety interval where this failure does not appear as a failure for a given safety interval. For instance, the influence of a failure “A claw is open” is terminated when the claw is back to a correct position.

Rule 5: The influence of a failure in the engineering process is not considered if it does not allow performing a regular technological operation, but does not result in overrun of an acceptable impact. For instance, if a claw moves downward in the position “The claw is closed”, thought landing of the claw onto a fuel assembly is impossible, this does not create a condition for the fuel assembly damage.

Rule 6: Engineering process failures relating to failures of the regular exploitation (unauthorized objects, deviation of geometrical sizes of a service area or reloaded products, etc.) are considered as acting if the start affecting the safety of an engineering process. For instance, an unauthorized object allocated in a reactor slot is not considered as a failure in the engineering process unless a fuel assembly is installed in a reactor slot where this object is allocated. The presence of an unauthorized object in a slot may result in failure in the installation of the fuel assembly in the correct position, and later this may result in the fall of the fuel assembly.

Further, on the basis of the documents described above a verbal model is created for future use in safety analysis of the engineering process.

On the third stage, the simulation of the engineering process is performed as follows.

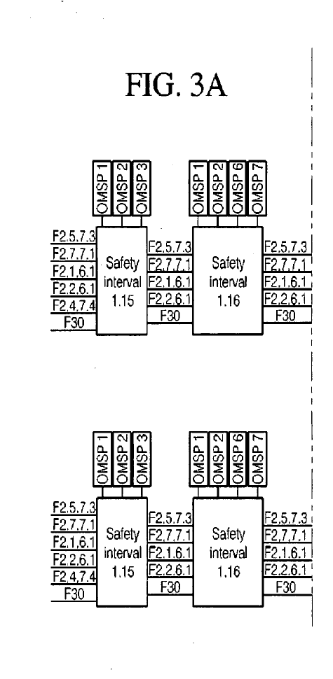

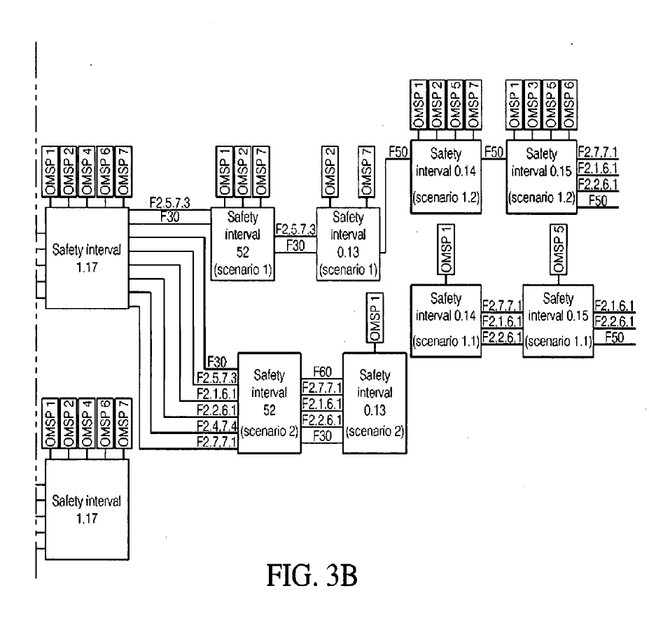

Using the propagation table obtained earlier, a deterministic-probabilistic model of a technological operation is constructed, taking into consideration possible transitions of failures to subsequent safety intervals (FIG. 3A-3B). This model represents a combination of safety intervals. At this stage, failures are considered that occur in a given safety interval, and those failures in the engineering process (FEP) that were transferred from a previous interval and resulted in overruns of accepted impacts at this interval or may result in overruns at the subsequent intervals.

The above model takes into consideration all possible scenarios and paths of events development to provide a qualitative safety evaluation of a technological operation. The results of this analysis may be used either as such or for subsequent quantitative safety evaluation of the engineering process.

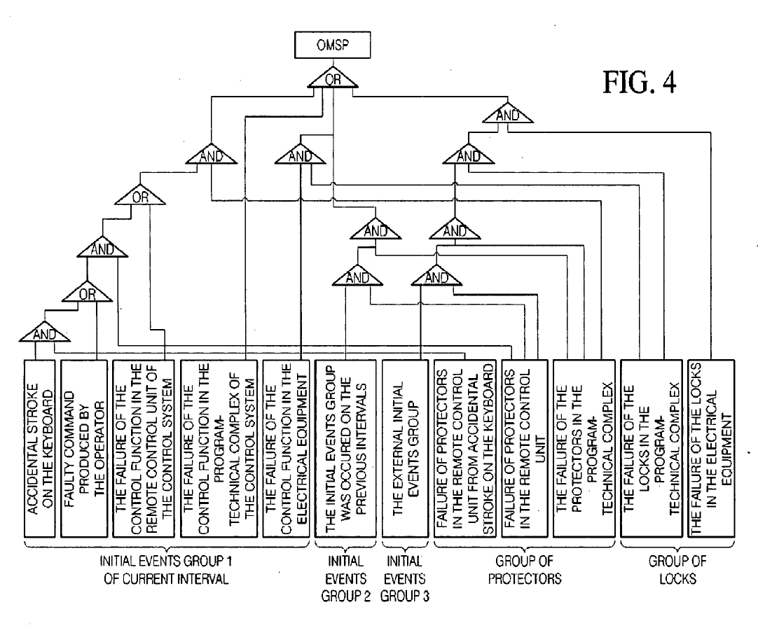

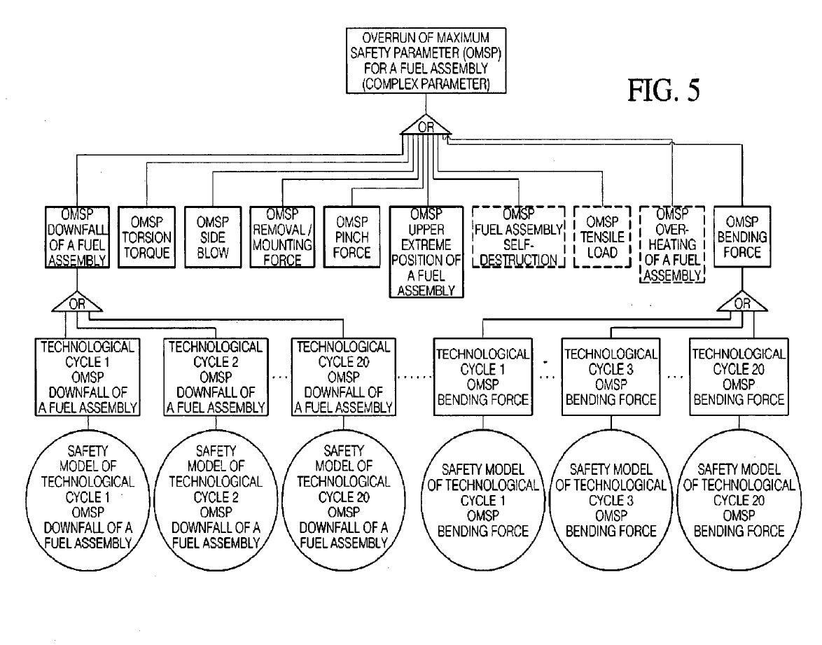

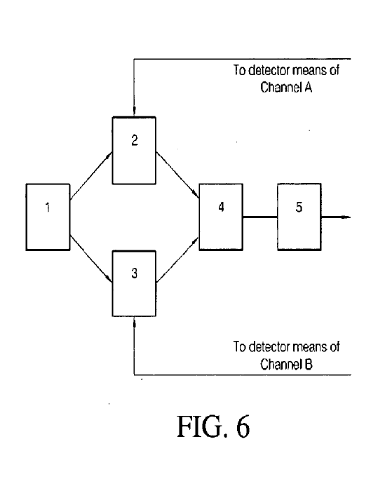

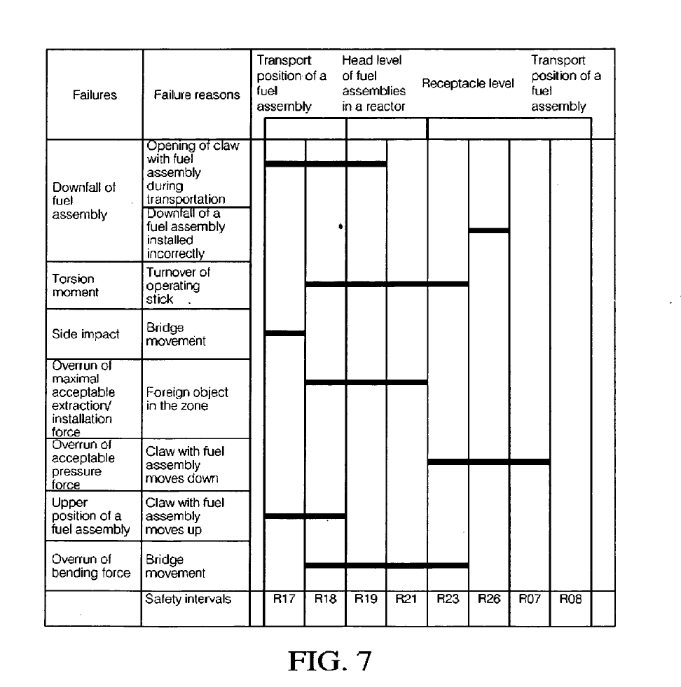

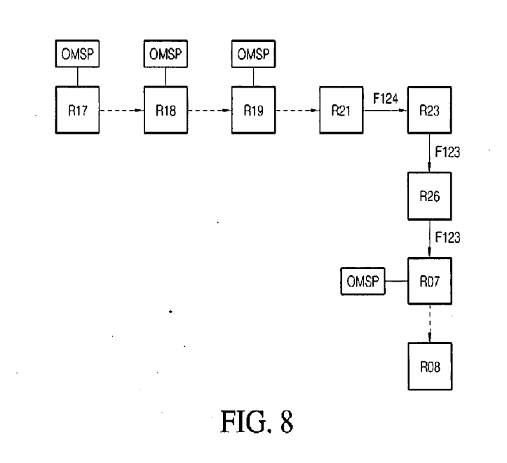

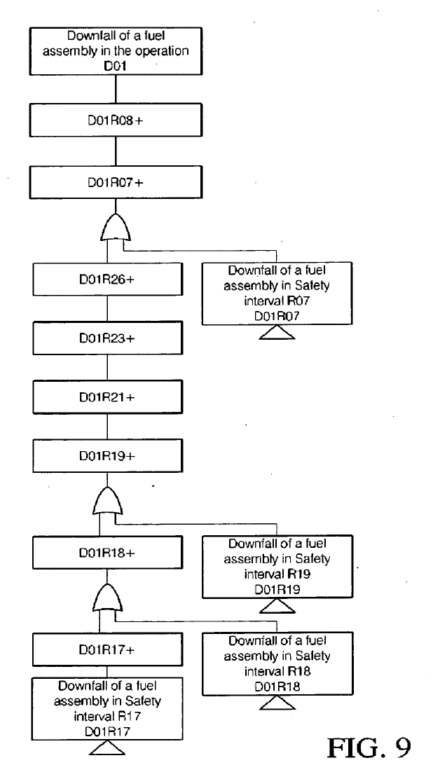

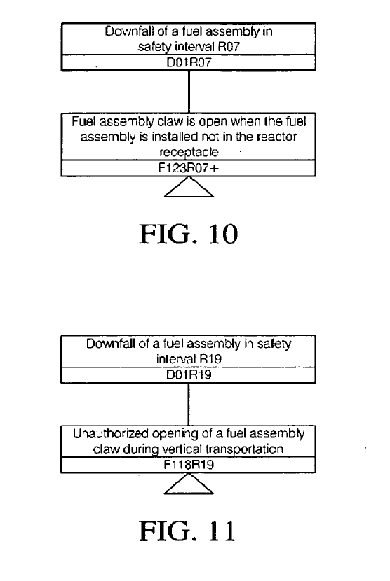

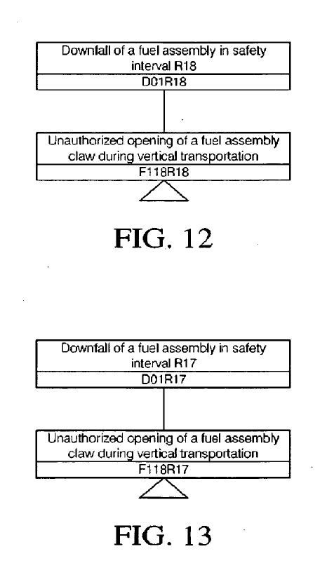

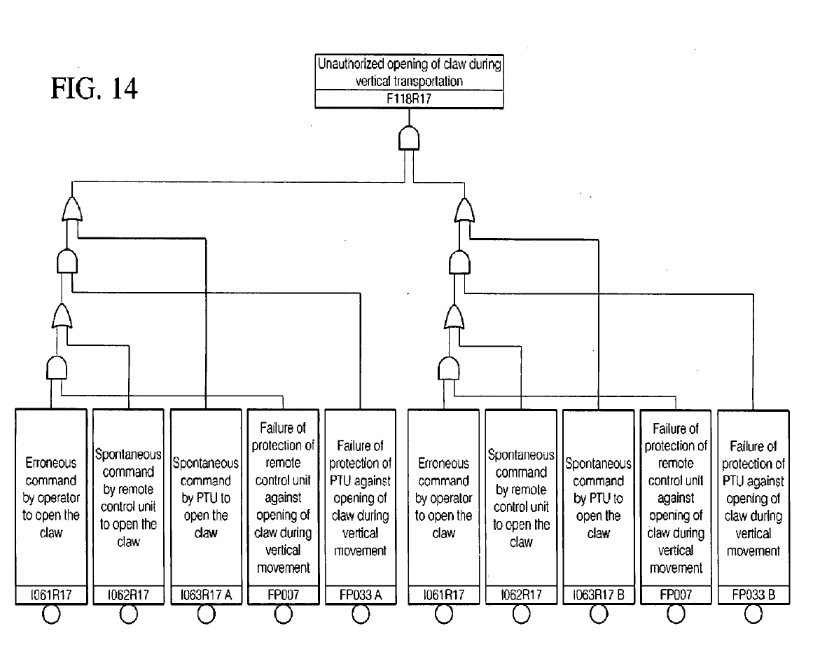

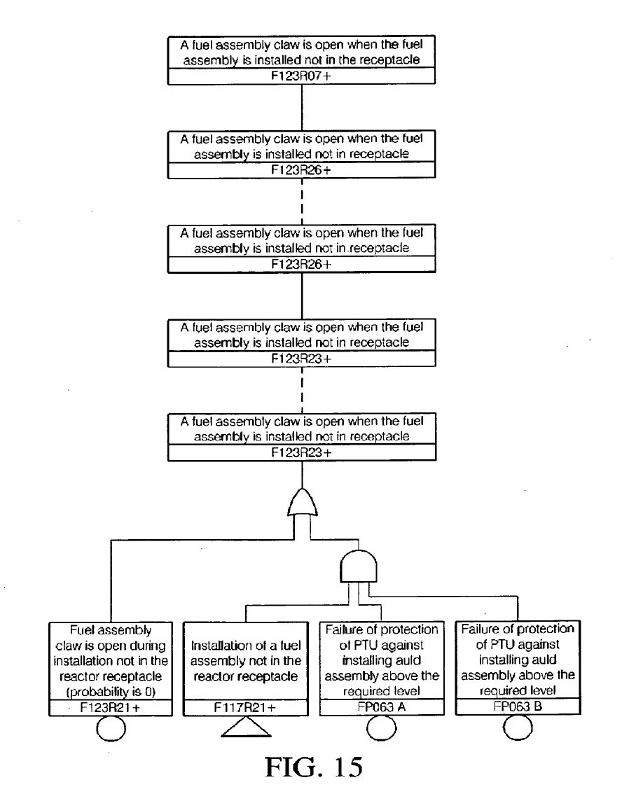

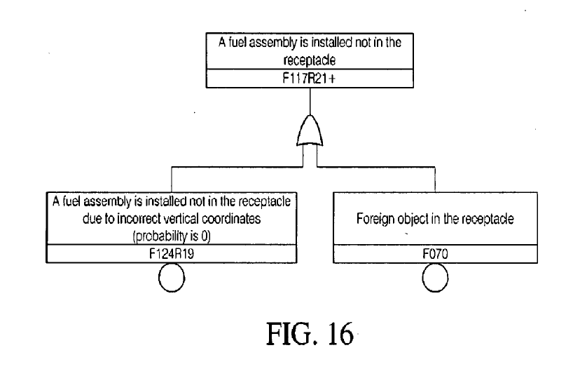

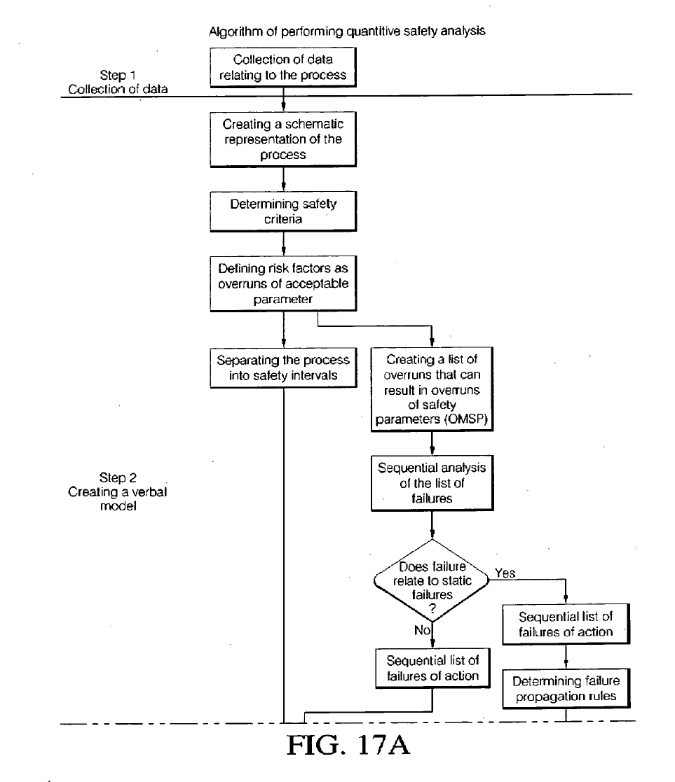

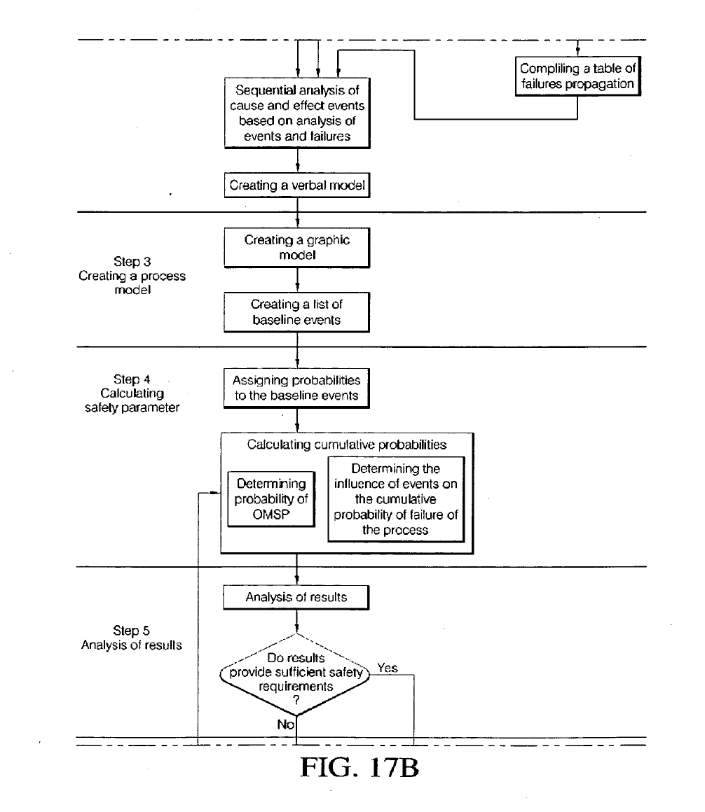

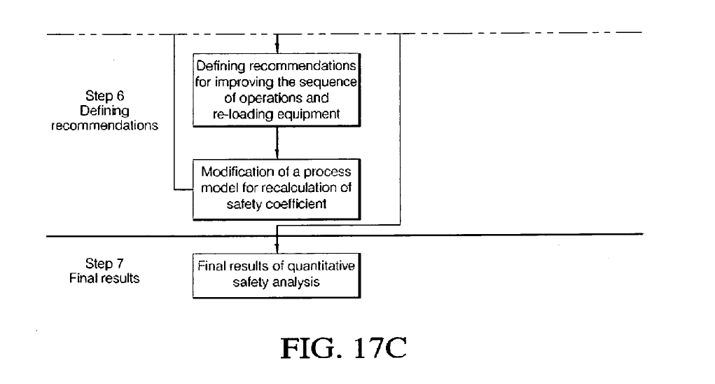

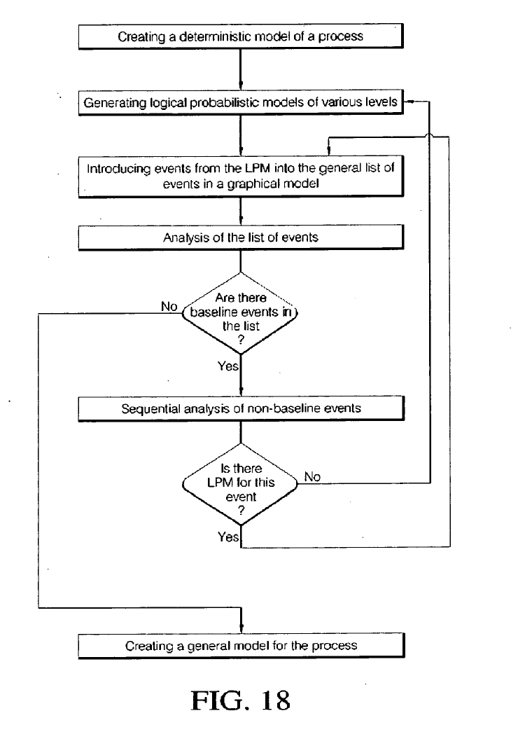

The next step is creating logical or logical-probabilistic models describing processes of initiation of OMSP for each safety interval (FIG. 4). At this stage, those failures in the engineering process (FEP) are considered that occur within the current safety interval or have propagated from a previous interval and resulted in OMSP (e.g. resulted in overrun of acceptable impact) in a given interval. Further, external impacts and protectors and locks available in the given safety interval are considered. To obtain quantitative indices, each failure in the engineering process (FEP) or failures of protectors and locks are taken into consideration with the respective probability of their occurrence.

The following events may be considered as an initiating impact: accidental stroke on the keyboard, faulty command produced by an operator, a control function failure in the remote control unit of a control system, a failure of a control function in a program-technical complex of a control system, a failure of a control function in electrical equipment.

The following events may be considered as an external impact: equipment failures (e.g. a reloading machine or its control system), exploitation personnel errors, deviation of geometric sizes of reloaded products of designed values, deviation of geometric sizes of designed values: reactor slots for fuel assemblies, rack cells in a detention pool, shells for fresh fuel and containers for used fuel; unauthorized objects located in a service area; water level decrease as a result of water flow through a coating of a detention pool; complete termination of power supply; seismic impact.

Protectors and locks may include, for instance, protectors and locks in a control system of a reloading machine. Protectors and locks can be separated into two groups: common protectors and locks, and protectors and locks of each device of a reloading machine.

Protectors and locks within the control system can be classified into the following groups in accordance with their mode of action:
Remote control unit-protectors;
Program-technical complex-protectors and locks;
Power supply complex-protectors and locks.

The advantage of the above method of distribution of protectors and locks is that it providing echeloning of protection and also, certain protectors and locks can be combined independently to provide the required conditions of safe exploitation.

Depending on objectives and tasks of a safety analysis, various modifications and combinations of the above described models are possible within the scope of the appended claims, including deterministic models of operations and logical-probabilistic models of failures in engineering processes.

For example, a technological cycle can be modelled by combining deterministic-probabilistic models of sequential technological operations, with subsequent modelling a whole process of reloading of a core region of the reactor (FIG. 5).

A model of a reloading process provides the opportunity to determine a combined safety index along with quantitative safety indices for each safety criterion.

On the fourth step, probabilistic safety indices of a core region reloading are calculated using the certified calculation complex “Risk Spectrum Professional”.

Calculation of quantitative probabilistic safety indices (safety criteria) is implemented as the following steps:
input of model data relating to a reloading process into a calculation complex;
possible failures are assigned a respective probabilistic coefficients;
protectors and locks are assigned their respective reliability coefficients;
calculations and analysis is performed;
results of calculations of probabilistic safety indices for the transport-technological operation “Installation of fuel assembly” are output;
results of analysis of influence of protectors and locks on the probabilistic safety indices are output.

On the fifth stage, safety indices characterising contribution of individual transport-technological operations and individual protectors and locks to the aggregate safety index of the engineering process of the core region reloading are analysed.

On the sixth stage, the proposals and recommendations are developed to improve the construction and circuit solutions of a reloading machine and its control system.

On the seventh stage, recommendations are developed to increase the safety level of APP when performing transport-technological operations with nuclear fuel.

A method for deterministic quantitative safety analysis of a nuclear power generating system is described below in more detail by way of the following example embodiment.

In the following example embodiment, the method is run in a Windows NT environment or simply on a stand alone computer system having a CPU, memory, and user interfaces. The method can also form a part of a nuclear power plant control system.

The said non-limiting example implementation describes an engineering process of nuclear fuel re-loading in a so-called boiling water (BWR) type nuclear reactor, in particular, in WWER (Water/Water-Energy Reactor)-1000 designed by the Russian Kurchatov Institute, Moscow, and also a control system and control method using the same.

What is claimed is:

1. A computer-implemented method of safety control of a high risk engineering process, wherein the process comprises a series of stages involving one or more non-stationary objects characterized by at least one variable risk factor, wherein the method comprises:
dividing, via a computer, the high risk engineering process into a plurality of safety intervals, such that each safety interval comprises a series of process stages and each process stage of the series of process stages is characterized by a combination of risk factors, wherein the combination remains invariable for each process stage of the series of process stages;
determining a sequential transition of failures of the engineering process and operation parameters from one safety interval to another, the sequential transition of failures being analyzed using cause-effect analysis;
for each safety interval, constructing, via the computer, at least one deterministic safety model based on results of an analysis of possible scenarios of sequential transitions of engineering process failures from one safety interval to another safety interval;
for each safety interval, performing, via the computer, qualitative and quantitative safety analysis; and
correspondingly modifying the engineering process to reach the required safety parameters.

2. A method of claim 1, further comprising, prior to dividing the engineering process, collecting process-specific data.

3. A method of claim 1, wherein the safety interval comprises a series of consecutive process stages.

4. A method of claim 1, wherein the method comprises, prior to dividing the engineering process, creating a computer readable representation of the high risk engineering process.

5. A method of claim 1, wherein creating the safety model comprises creating a deterministic safety model.

6. A method of claim 1, wherein performing the qualitative and quantitative safety analysis comprises calculating probabilities of risk factors.

7. A method of claim 6, wherein the risk factors comprise engineering process and operation parameter failures, which may result in at least one overrun of a maximum safe operation parameter.

8. A method of claim 6, wherein a distribution analysis of the risk factors throughout different stages of the engineering process is performed using a process representation in computer readable form.

9. A method of claim 1, wherein the process is characterized by at least one process parameter Pᵢ (1<i<n), which is defined as any measurable physical parameter related to or acting upon an object involved in the engineering process, and wherein, for each variable process parameter, a maximum permissible value Pᵢₘₐₓ is defined in accordance with safety requirements for the associated engineering process.

10. A method of claim 1, wherein the process is divided into safety intervals in the time domain.

11. A computer-implemented method of safety control of a high risk engineering process of a nuclear core loading, wherein the method comprises:
defining safety criteria as maximum safe operation parameters, wherein said operation parameters include process parameters or forces acting upon objects involved in the process;
comparing, via a computer, actual measured operation parameters with the safe operation parameters to determine risk factors, which may result in overrun of the maximum safe operation parameters;
for each determined risk factor, defining a plurality of process stages, which are affected by the said risk factor;
determining one or more safety intervals, such that each safety interval comprises a series of consecutive process stages and each process stage of the series of process stages is characterized by a combination of the risk factors, wherein the combination remains invariable for each process stage of the series of process stages;
determining sequential transitions of risk factors from one safety interval to another safety interval using cause-effect analysis;
for each determined safety interval, constructing, via the computer, deterministic safety models based on analysis of possible scenarios of the determined sequential transitions of risk factors from one safety interval to another safety interval and calculating probabilities of risk factors in the safety interval; and
modifying, via the computer, a control system based upon the calculated probabilities to reach the required safety parameter of the process.

12. A method of claim 11, wherein defining the plurality of process stages comprises performing distribution analysis of the risk factors throughout different stages of the engineering process using a process representation in computer readable form.

13. A method of claim 11, further comprising constructing one or more logical or logical-probabilistic models for at least one risk factor.

14. A method of claim 13, further comprising creating at least one deterministic-probabilistic safety model of the whole engineering process using the logical-probabilistic models.

15. A method of claim 13, further comprising creating at least one deterministic-probabilistic safety model of the whole engineering process using the determined safety intervals and the logical-probabilistic models.

16. A method of claim 13, wherein said logical or logical-probabilistic models are constructed based upon analysis of risk factors, which separately or in combination, potentially result in run-over of the respective engineering process parameters.

17. A method of claim 16, further comprising creating at least one deterministic-probabilistic safety model of the whole engineering process using the determined safety intervals.

18. A method of claim 11, wherein the actual operation parameters for the current engineering process are obtained prior to comparing the measured and the safe operation parameters using measurement devices.

19. A method of claim 11, wherein the objects involved in the process are non-stationary objects having safety parameters varying with time or allocation of the said object in a particular process stage.

20. A method of claim 19, wherein the said non-stationary object is selected from at least one of the following: an engineering process, at least one stage or part of an engineering process, at least one product, at least one device, at least one unit, a combination thereof, wherein the safety conditions of the object vary depending on time and allocation of the object.

21. A method of claim 11, further comprising plotting diagrams of partitioning into safety intervals.

22. A method of claim 12, further comprising performing analysis of failure transitions in the engineering process based on cause-effect relations of a combination of parameters selected from risk factors, possible failures in engineering process, and malfunction of protectors or locks on each stage of the engineering process.

23. A method of claim 11, wherein performing analysis of risk factors distribution is performed by considering each separate stage of the engineering process to determine a particular risk factor, which could result in overrun of any one acceptable operation parameter.

24. A method of claim 11, further comprising creating logical-probabilistic models using probabilistic coefficients for each event of the model.

25. A method of claim 11, further comprising separating the engineering process into safety intervals with account of each risk factor in each stage or part of the engineering process for each safety parameter.

26. A method of claim 11, further comprising performing quantitative analysis of safety.

27. A method of claim 11, further comprising determining necessary and sufficient number of protectors and locks.

28. A method as recited in claim 11, further comprising optimizing the structure of the control system of said engineering process.

29. A method as recited in claim 11, comprising determining valid safety parameters of equipment reliability to provide safety parameters of the process.

30. A system for safety control of a high risk engineering process, wherein the process comprises a series of stages involving non-stationary objects characterized by at least one variable risk factor, wherein the system comprises:
a central processor configured to perform the safety analysis;
a data storage in data communication with the central processor;
an engineering process modeler;
wherein the central processor is further configured to
calculate probabilistic safety parameters;
analyze risk factors distribution areas;
analyze transitions of engineering process failures from one safety interval to another safety interval using cause-effect analysis; and
partition the modeled engineering process into a plurality of safety intervals, such that each safety interval comprises a series of at least one process stage, and each process stage of the series of process stages, for which safety conditions comprise a combination of risk factors, is characterized by the combination of risk factors, wherein the combination remains invariable for each process stage of the series of process stages; and wherein the engineering process modeler is further configured to create deterministic safety models taking into consideration possible scenarios of transitions of engineering process failures from one safety interval to another safety interval.

31. A system of claim 30, wherein the data storage is configured to store at least one of the following: process-specific data for analysis of safety regulations: a list of safety criteria, and a list of maximum safe operation parameters overruns.

32. A system of claim 30, wherein the central processor is further configured to perform a qualitative and quantitative safety analysis.

33. A system of claim 30, wherein the central processor is further configured to create a deterministic-probabilistic model.

34. A system of claim 30, configured to compute safety parameters, which characterize contribution of individual technological operations and individual protectors and locks into a general safety parameter of the overall engineering process of nuclear fuel reloading.

35. A system of claim 30, wherein the central processor is further configured to create at least one failure propagation scenario using a database for storing statistical information on probabilities of occurrence of various events in the engineering process.

36. A system of claim 30, wherein the central processor is further configured to:
create an engineering process flowchart;
create a matrix of safety criteria;
create a matrix of engineering process failures; and
wherein the system further comprises:
a matrix of initial events; and
a matrix of protectors and locks.

37. A control system configured to control a high risk engineering process of a nuclear core loading, the system having a required safety parameter, wherein the system comprises:
a data storage configured to store maximum safe operations parameters;
a central processor in data communication with the data storage, the central processor being configured to
detect at least one process parameter acting upon one or more objects involved in the engineering process;
compare the actual detected at least one process parameter with the stored maximum safe operating parameter to determine risk factors;
create a matrix of distributions of risk factors within a plurality of process stages, indicate those process stages which are affected by the risk factor, and determine one or more safety intervals, such that each safety interval comprises a series of consecutive process stages and each process stage of the series of process stages is characterized by a combination of the risk factors, wherein the combination remains invariable for each process stage of the series of process stages;
create a deterministic safety model for each safety interval taking into consideration possible scenarios of transitions of engineering process failures from one safety interval to another safety interval, and calculate probabilities of risk factors; and
perform modifications based upon the calculated probabilities to reach the required safety parameter of the process.

38. A system of claim 37, wherein the central processor is further configured to perform qualitative and quantitative safety analysis.

39. A system of claim 37, wherein the central processor is further configured to create a deterministic-probabilistic model.

40. A non-transitory medium comprising computer readable code, which, when executed causes the computer to perform a computer-implemented method of safety analysis of a high risk engineering process, wherein the process comprises a series of stages involving one or more non-stationary objects characterized by at least one variable risk factor, wherein the method comprises:
dividing, via a computer, the high risk engineering process into a plurality of safety intervals, such that each safety interval comprises a series of process stages and each process stage of the series of process stages is characterized by a combination of risk factors, wherein the combination remains invariable for each process stage of the series of process stages;
determining a sequential transition of failures of the engineering process and operation parameters from one safety interval to another, the sequential transition of failures being analyzed using cause-effect analysis; and
for each safety interval, constructing, via a computer, at least one deterministic safety model based on results of an analysis of possible scenarios of sequential transitions of engineering process failures from one safety interval to another safety interval;
for each safety interval performing, via a computer, qualitative and quantitative safety analysis; and
correspondingly modifying the engineering process to reach the required parameters.
